(19) United States
(12) Patent Application Publication
(10) Pub. No.: US 2024/0279130 A1
(43) Pub. Date: Aug. 22, 2024

(54) STORAGE STABLE PIGMENTED COATING COMPOSITION

(71) Applicant: Arkema Inc., King of Prussia, PA (US)

(72) Inventors: Lei YANG, King of Prussia, PA (US); Wenjun WU, King of Prussia, PA (US); Jeffrey A. SCHNEIDER, King of Prussia, PA (US)

(21) Appl. No.: 18/290,323

(22) PCT Filed: May 24, 2022
(86) PCT No.: PCT/US2022/030693

§ 371 Date: Nov. 13, 2023

Related U.S. Application Data
(60) Provisional application No. 63/193,657, filed on May 27, 2021.
(60) Provisional application No. 63/304,717, filed on Jan. 31, 2022.
(60) Provisional application No. 63/304,720, filed on Jan. 31, 2022.

(51) Int. Cl. C04B 41/48; C04B 41/00; C04B 41/45; C04B 41/63; C08F 220/56; C08K 3/22; C08K 3/34; C08K 5/00; C08K 13/02; C09D 5/02; C09D 7/41; C09D 7/45; C09D 7/61; C09D 133/26

(52) U.S. Cl. CPC C04B 41/4834; C04B 41/009; C04B 41/4539; C04B 41/63; C08F 220/56; C08K 13/02; C09D 5/022; C09D 5/027; C09D 5/028; C09D 7/41; C09D 7/45; C09D 7/61; C09D 133/26; C08K 2003/2241; C08K 2003/343; C08K 5/0041; C08K 2201/014

(57) ABSTRACT

A method of coating a cementitious and/or masonry substrate includes applying an aqueous coating composition to the cementitious and/or masonry substrate. The aqueous coating composition includes at least one pigment, optionally at least one filler, at least one emulsified polymeric binder, at least one water-soluble silicate, and optionally at least one additive. The emulsified polymeric binder includes at least one of: a)(meth)acrylamide or derivative thereof as a polymerized monomer; or b) 1 weight % or more of at least one surfactant based on the total dry weight of the total monomer in the emulsified polymeric binder. The aqueous coating composition has a weight ratio of emulsified polymeric binder to the water-soluble silicate from 65:35 to 95:5 on a dry weight basis. The aqueous coating composition also has a pigment volume concentration (PVC) from 5% to 85.

### FIELD OF THE INVENTION

This invention is directed to a one-part waterborne (aqueous) pigmented coating compositions that are storage stable and adhere to cementitious and/or masonry substrates. The compositions are especially useful as paints on cementitious/masonry substrates.

### BACKGROUND

It is now generally accepted that cementitious and/or masonry substrates, such as concrete surfaces, are not highly durable. One economic approach to improve the durability of these substrates is to apply a surface protective coating. However, adhesion of the coating composition to these substrates is a challenging property because these substrates are complex both chemically and physically.

Latex polymers have been widely used as waterborne organic binders in modern coating industry due to their low volatile organic contents and good film formation capability. However, conventional latex-based coatings showed poor adhesion on friable cementitious and/or masonry substrates such as concrete surfaces. Therefore, latex-based coatings often require surface preparation steps (e.g., acid treatment and sandblasting) prior to applying the coating in order to achieve desired adhesion. However, these surface preparation steps are labor intensive and may release hazardous chemicals into the environment, such as wastewater after acid etching.

On the other hand, alkali metal silicates (e.g., potassium silicate, sodium silicate) have been widely used as waterborne inorganic binders for cementitious and/or masonry coatings, due to their capability to provide good adhesion. Although latex polymers have been used as additives in silicate paints to make “dispersion silicate paints”, the total weight percentages of latex polymers and other organic matters are restricted to below 5 weight % according to DIN 18363 standard (Painting and coating work Section 2.4.1.) Due to the absence or low levels of organic binders present in conventional silicate paints or dispersion silicate paints, the film formation capability of silicate-based coatings is poor, particularly when the coating is applied at low temperatures.

Since latex coatings have desirable properties, such as good film formation, while the silicate containing coating compositions are able to provide a coating that adheres well to cementitious/masonry substrates (e.g., concrete substrates), a hybrid coating composition would be desirable and useful. However, such hybrid coating compositions including both silicate and latex typically are unstable in storage. This storage instability may manifest as viscosity rise, coagulation, changes in particle size, and/or phase separation. Without being bounded to the theory, this instability is particularly evident in the pigmented coating composition, as the presence of pigments may result in more undesired interactions with latex and/or silicate that cause instability compared to non-pigmented systems. Thus, previous such compositions have relied on either a two-part coating composition, in which the latex and the silicate components are kept separate and only combined immediately prior to use, or have included stabilizers, which may adversely affect coating performance. These stabilizers also may be costly and often do not contribute to the overall adhesion and durability of the resultant coating.

U.S. Pat. No. 4,294,874 discloses a storage stable coating including about 15 percent to about 40 percent of an alkali metal or quaternary ammonium silicate and from about 60 percent to about 85 percent of a latex. The compositions are useful for the filling of low grade wood products.

US 2019/0177558 discloses dialkylglucosamines as stabilizers for coating compositions that comprise both latex and silicate.

EP 3712216 discloses N, N, N′, N′-tetrakis (2-hydroxypropyl) hexane-1,6-diamine as a viscosity stabilizer in aqueous coating compositions containing silicate and at least one organic polymeric binder.

EP 2081998 discloses nitrogen containing compounds having molecular weight from 120 to 10,000 Daltons combined with alkyl siliconates as viscosity stabilizers for coating compositions containing water, fillers and/or pigments as well as low levels of a binder.

EP 1297079 discloses a preservative-free aqueous emulsion paint containing a) 4-15 weight % of polymer dispersion, calculated as the solids content; b) 10-55 weight % of pigment and/or filler and c) a maximum of 2 weight % of water-glass as an additive and water to make up to 100%.

WO 2020/180616 discloses a water-based coating composition containing a pigment, a polymeric dispersion and a hydrolysable silane intended for preservative-free applications. Optionally, 0.1 to 4 weight %, of either or both of silicates and siliconates may be included. The polymeric dispersion contains a hydrolysable silane.

WO 2020/002102 discloses a biocide-free pigmented paint composition including 5 to 50 weight % polymer dispersion polymerized by 2-ethyl hexyl acrylate, butyl acrylate, and one or more vinylaromatics, 0.1 to 5 weight % alkali metal silicate or siliconate, 20 to 70 weight % inorganic fillers, 0 to 30 weight % inorganic pigments, with pigment volume concentration (PVC) ranging from 60% to 90%.

U.S. Pat. No. 9,051,488 discloses a multifunctional primer formulation including a latex-silicate binder, where latex to silicate ratio is between 0.5 to 1.5.

US 2021/0230431 discloses an emulsion composition including 8 to 30 weight percent of acrylic polymer and 4 to 10 weight percent of metal silicate.

Accordingly, a need remains for a one-part storage stable composition that can provide good film formation and robust adhesion on cementitious and/or masonry substrates, including minimally prepared substrates that were not subjected to extensive surface treatments. There is also a need for a storage stable one-part pigmented system that does not include additional stabilizers.

### SUMMARY

This invention is directed to a one-part storage stable coating composition that includes pigments, optional fillers, emulsified polymeric (organic) binders, water-soluble silicates, and optional additives. The one-part coating composition can be directly used on cementitious and/or masonry substrates, such as concrete or other inorganic substrates to provide good adhesion. Specifically, the one-part composition utilizes a hybrid technology combining latex and silicate as film-forming binders to yield a pigmented coating composition that can be directly applied onto cementitious and/or masonry substrates or other difficult inorganic substrates. The resulting one-part coating compositions showed good film formation behavior even when applied under low temperature conditions and were capable of providing consistent adhesion to cementitious and/or masonry substrate substrates, including substrates that were not subjected to extensive surface preparation steps.

Importantly, the storage stability is achieved when the emulsified polymeric binder comprises, consists of or consists essentially of either or both of the following components:
a) (meth)acrylamide or derivatives thereof as a polymerized monomer; or
b) 1 weight % or more of at least one surfactant based on the total dry weight of the total monomer in the emulsified polymeric binder.

A method of coating a cementitious and/or masonry substrate is provided. The method comprises, consists of or consists essentially of applying a one-part aqueous coating composition to the cementitious and/or masonry substrate. The aqueous coating composition comprises, consists of or consists essentially of at least one pigment, optionally at least one filler, at least one emulsified polymeric binder, at least one water-soluble silicate, and optionally at least one additive. The emulsified polymeric binder comprises, consists of or consists essentially of at least one of:
a) (meth)acrylamide or derivatives thereof as a polymerized monomer; or
b) 1 weight % or more of at least one surfactant based on the total dry weight of the total monomer in the emulsified polymeric binder.

The one-part aqueous coating composition has a weight ratio of emulsified polymeric binder to the water-soluble silicate from 65:35 to 95:5, preferably from 70:30 to 90:10, more preferably from 75:25 to 85:15 on a dry weight basis. The aqueous coating composition also has a pigment volume concentration (PVC) from 5% to 85%, preferably from 15% to 75%, more preferably from 20% to 70%.

The PVC of the coating composition is defined as:

$$\frac{dry volume of ( pigment + filler )}{dry volume of ( pigment + filler + water soluble silicate + p o l y meric binder )} \times 100.$$

A one-part aqueous composition for coating a cementitious and/or masonry substrate is also provided. The one-part aqueous composition comprises, consists of or consists essentially of the following components: at least one pigment; optionally at least one filler; at least one emulsified polymeric binder, at least one water-soluble silicate, and optionally at least one additive. The emulsified polymeric binder comprises, consists of, or consists essentially of either or both of:
a) (meth)acrylamide or derivatives thereof as a polymerized monomer; or
b) at least one surfactant.

The pigment, the optional filler, the emulsified polymeric binder, the water soluble silicate, and the optional additives are present in the one-part aqueous composition in amounts effective to achieve the adhesion of the coating composition to cementitious and/or masonry substrate and to be storage stable as a one-part composition. The one-part aqueous coating composition also has a weight ratio of the emulsified polymeric binder to the water-soluble silicate on a dry weight basis effective to achieve the adhesion of the dried aqueous coating composition to the cementitious and/or masonry substrate and to achieve the storage stability. The one-part aqueous composition has a pigment volume concentration (PVC) of the aqueous coating composition effective to achieve the adhesion of the dried aqueous coating composition to the cementitious and/or masonry substrate and effective to achieve storage stability as a one-part composition. The PVC is defined as:

$$\frac{dry volume of ( pigment + filler )}{dry volume of ( pigment + filler + water soluble silicate + p o l y meric binder )} \times 100.$$

### BRIEF DESCRIPTION OF THE FIGURES

FIG. 1 shows the adhesion performance of inventive Example 1, inventive Example 3, comparative Example 1, and comparative Example 3 on concrete substrates; and

FIG. 2 shows adhesion performance on concrete of inventive Example 1 (A) and inventive Example 2 (B).

### DETAILED DESCRIPTION

As used herein, all percentages are percentage by weight unless stated otherwise.

“Cementitious substrate” as used herein means a cured or uncured surface comprising one or more minerals which hardens when exposed to water including, but not limited to, clay, calcium, calcined lime, sand, gravel, a powder of alumina, silica, silicon, iron oxide, magnesia and combinations thereof. “Cementitious substrate” as used herein is interchangeable with cement, concrete, and/or mortar. As used herein, a “cured” cementitious substrate is one that has been exposed to water and is at least partially hydrated and/or hardened. “Masonry substrate” as used herein means a substrate that comprises individual units, which are laid in and bound together by mortar. Common materials of masonry construction include brick, building stone such as marble, granite, and limestone, cast stone, concrete block, glass block, and adobe. Mortar is a mixture of cement, lime, and sand.

The terms “latex” and “emulsified polymeric binder” are used interchangeably.

As used herein, “acrylamide” refers to a vinyl monomer containing amide group —C═O—NHR or ethylenically unsaturated carboxylic amide.

The aqueous compositions for coating cementitious and/or masonry substrates are one-part compositions. “One-part” composition as used herein distinguishes the compositions of the present invention from “two-part” compositions where the latex and silicate components are kept in separate units/pots/systems such that they are only combined immediately prior to use.

### Emulsified Polymeric Binder

The amount of emulsified polymeric binder in the one-part aqueous composition may be from 2 to 40, preferably from 3 to 30, and more preferably from 4 to 25 weight percent, based on the total weight of the aqueous composition.

The emulsified polymeric binder also comprises, in addition to the 1 weight % or more of surfactant or the effective amount (meth)acrylamide or derivatives thereof, as polymerized monomer, one or more of a vinyl aromatic or derivatives thereof, an alkyl (meth)acrylate or derivatives thereof, and/or carboxylic acid monomer, such as (meth)acrylic acid, itaconic acid, and maleic acid.

The emulsified polymeric binder may comprise, as a polymerized monomer, from 0.1 to 99.9, preferably 10 to 90, more preferably, 20 to 80 weight % of an alkyl (meth)acrylate based on the dry weight of the emulsified polymeric binder. The polymeric binder a) may comprise at least 0.2, 0.3, 0.5, 0.6, 0.7, 0.8, 0.9, 1, 3, 5, 10, 15, 20, 25, 30, 35, 40, 45, 50, 55, 60, 65, 70, 75, 80, 90, 95, or 99 weight % of an alkyl (meth)acrylate, based on the dry weight of binder a). The polymeric binder a) may comprise at most 99.9, 99.5, 95, 90, 80, 75, 70, 65, 60, 55, 50, 45, 40, 35, 30, 25, 20, 15, 10, 5, 3, 1, 0.9, 0.8, 0.7, 0.6, 0.5, 0.3, or 0.2 weight % of an alkyl (meth)acrylate, based on the dry weight of the emulsified polymeric binder.

Non-limiting examples of suitable alkyl (meth)acrylates are alkyl esters of (meth)acrylic acid, for example. Non-limiting examples include methyl (meth)acrylate, ethyl (meth)acrylate, butyl (meth)acrylate, cyclohexyl (meth)acrylate, allyl methacrylate, 2-ethylhexyl acrylate; iso-octyl methacrylate and iso-octyl acrylate, lauryl acrylate and lauryl methacrylate, stearyl acrylate and stearyl methacrylate, isobornyl acrylate and isobornyl methacrylate monomers.

The emulsified polymeric binder may comprise, as a polymerized monomer, from 0 to 90 weight %, preferably from 10 to 90 weight %, more preferably from 20 to 80 weight % of a vinyl aromatic monomer based on the dry weight of the polymeric binder a). Non-limiting examples include styrene, alkyl styrenes and derivatives thereof, such as alpha-methyl styrene. The vinyl aromatic monomer may be present in the in the emulsified polymeric binder at a level of at least 0, 0.1, 0.2, 0.5, 0.6, 0.7, 0.8, 0.9, 1, 3, 5, 10, 15, 20, 25, 30, 35, 40, 45, 50, 55, 60, 65, 70, 75, 80, 85, 90, 95, or 99 weight %, based on the dry weight of binder a). The vinyl aromatic monomer may be present in the polymeric binder at a level of at most 99.5, 99, 95, 90, 85, 80, 75, 70, 65, 60, 55, 50, 45, 40, 35, 30, 25, 20, 15, 10, 5, 3, 1, 0.9, 0.8, 0.7, 0.6, 0.5, 0.1, or 0 weight %, based on the dry weight of the polymeric binder a).

Other suitable monomers that are capable of free radical polymerization may be included in the emulsified polymeric binder at levels from about 0 to 99.5 weight %, preferably 0 to 20, more preferably 0 to 10 weight % based on the dry weight of the emulsified polymeric binder. For example these other suitable monomers may be included in the polymeric binder a) at about 0, 0.2, 0.3, 0.5, 0.6, 0.7, 0.8, 0.9, 1, 3, 5, 10, 15, 20, 25, 30, 35, 40, 45, 50, 55, 60, 65, 70, 75, 80, 90, 95, or 99 weight %, based on the dry weight of emulsified polymeric binder. These other suitable monomers may be present in the polymeric binder a) at a level of at least 0, 0.1, 0.2, 0.5, 0.6, 0.7, 0.8, 0.9, 1, 3, 5, 10, 15, 20, 25, 30, 35, 40, 45, 50, 55, 60, 65, 70, 75, 80, 85, 90, 95, or 99 weight %, based on the dry weight of binder a). These other suitable monomers may be present in the emulsified polymeric binder at a level of at most 99.5, 99, 95, 90, 85, 80, 75, 70, 65, 60, 55, 50, 45, 40, 35, 30, 25, 20, 15, 10, 5, 3, 1, 0.9, 0.8, 0.7, 0.6, 0.5, 0.1, or 0 weight %, based on the dry weight of the emulsified polymeric binder. These other suitable monomers may include various carboxylic acids such as itaconic acid, and esters thereof, various esters of versatic acid, methoxyethyl acrylate and methoxy ethyl methacrylate, 2-ethoxy ethyl acrylate and 2-ethoxy ethyl methacrylate, and combinations thereof. Also suitable as optional monomers are acrylonitrile; vinyl cyanides; vinylpyrrolidone; polypropylene glycol mono(meth)acrylate or polyethylene glycol mono(meth)acrylate; phosphorous-based monomers including but are not limited to phosphoalkyl (meth)acrylates or acrylates, phospho alkyl (meth)acrylamides or acrylamides, phosphoalkyl crotonates, phosphoalkyl maleates, phosphoalkyl fumarates, phosphodialkyl (meth)acrylates, phosphodialkyl crotonates, vinyl phosphates and (meth)allyl phosphate, phosphate esters of polypropylene glycol mono(meth)acrylate or polyethylene glycol mono(meth)acrylate, polyoxyethylene allyl ether phosphate, vinyl phosphonic acid. Suitable sulfur-based monomers include, but are not limited to, vinyl- and allyl-sulfonic or sulfuric acids, sulfoethyl (meth)acrylate, aryl-sulfonic or sulfuric acids, (meth)acrylamidoethane sulfonic or sulfuric acids, (meth)acrylamido-2-methylpropane sulfonic or sulfuric acids, and the alkali metal salts of sulfonic and sulfuric acids.

The emulsified polymeric binder may optionally further comprise, as polymerized monomer, from 0 to 5 weight % of a crosslinkable co-monomer, a silane co-monomer, a phosphate co-monomer, or a sulfonate co-monomer, based on the dry weight of the emulsified polymeric binder. For example, the emulsified polymeric binder may include, as a polymerized monomer, from 0.05 to 4, or from 0.1 to 3 weight percent of a crosslinkable co-monomer, a silane co-monomer, a phosphate co-monomer, or a sulfonate co-monomer, based on the dry weight of the emulsified polymeric binder. The emulsified polymeric binder may include at least 0.01, 0.05, 0.2, 0.3, 0.5, 0.8, 1, 1.2, 1.5, 2, 2.5, 3, 3.5, 4, or 4.5 weight percent of a crosslinkable co-monomer, a silane co-monomer, a phosphate co-monomer, or a sulfonate co-monomer, based on the dry weight of the emulsified polymeric binder. The emulsified polymeric binder may include at most, 5, 4.5, 4, 3.5, 3, 2.5, 2, 1.5, 1, 0.8, 0.6, 0.5, 0.3, 0.2 or 0.1 weight percent of a crosslinkable co-monomer, a silane co-monomer, a phosphate co-monomer, or a sulfonate co-monomer, based on the dry weight of the emulsified polymeric binder.

Suitable optional silane co-monomers include, but are not limited to methacryloxypropyl trimethoxysilane, methacryloxypropyl triethoxysilane, methacryloxypropyl tripropoxysilane, vinyltriacetoxysilane, vinyltrimethoxysilane, and vinyltriethoxysilane. The more preferred silane co-monomers are methacryloxypropyl trimethoxysilane and vinyltrimethoxysilane.

If present, these crosslinkable co-monomers may be of two different types. The first type is crosslinkable co-monomers that include two or more sites of ethylenic unsaturation such that the crosslinks are formed during polymerization of the polymeric binder a). The second type of crosslinkable co-monomer are those that include, in addition to an ethylenic unsaturation ((meth)acrylate, allyl or vinyl functional groups), at least one moiety that is capable of reacting with a separate crosslinking compound that may be included in the one-part aqueous composition to form a crosslink.

Suitable crosslinkable co-monomers with two or more sites of ethylenic unsaturation include, but are not limited to, ethylene glycol dimethacrylate, diethylene glycol dimethacrylate, trimethylolpropane trimethacrylate, 1,3-butyleneglycol dimethacrylate, and 1,4-butyleneglycol dimethacrylate, hexanediol dimethacrylate, divinyl benzene, diallyl phthalate.

Crosslinkable co-monomers that are capable of reacting with a separate crosslinking agent that may be included in the one-part aqueous composition may be selected from, for example, acetoacetate co-monomers containing (meth)acrylate, allyl or vinyl functional groups including but not limited to acetoacetate moieties such as: 2-acetoacetoxyethyl (meth)acrylate, 3-acetoacetoxypropyl (meth)acrylate, 4-acetoacetoxybutyl (meth)acrylate, 2-cyanoacetoxyethyl (meth)acrylate, 3-cyanoacetoxypropyl (meth)acrylate, 4-cyanoacetoxybutyl (meth)acrylate, N-(2-acetoacetoxyethyl) (meth)acrylamide, allyl acetoacetate, 2,3-di(acetoacetoxy)propyl (meth)acrylate, vinyl acetoacetate and combinations thereof. Also suitable are co-monomers containing a keto group such as diacetone acrylamide. The more preferred crosslinkable monomers are acetoacetoxyethyl methacrylate and diacetone acrylamide. Water-soluble crosslinking agents that can react with certain moieties of these second type of crosslinkable co-monomers may also optionally be included in the one-part aqueous composition. These water soluble crosslinking agents effect post crosslinking during film formation and drying by reacting with the crosslinkable moieties on the second type of crosslinkable co-monomers. For example, such crosslinking agents containing at least two hydrazine and/or hydrazide groups may be included in certain embodiments of the one-part aqueous composition. Preferred such separate crosslinking agents are water soluble. Non-limiting examples include oxalic acid dihydrazide, malonic acid dihydrazide, succinic acid dihydrazide, glutaric acid dihydrazide, adipic acid dihydrazide, sebacic acid dihydrazide, maleic acid dihydrazide, fumaric acid dihydrazide and/or itaconic acid dihydrazide. Adipic acid dihydrazide (ADH) is a preferred water-soluble cross-linking agent for use in the compositions herein, especially those produced from monomer compositions containing diacetone acrylamide (DAAM). Other suitable water-soluble cross-linking agents are compounds which contain at least two amine functional moieties such as ethylene diamine and hexamethylene diamine. Such cross-linking agents are preferred in combination with polymers comprising 1,3-dicarbonyl groups as the crosslinkable moiety, such as acetoacetoxyethyl methacrylate (AAEM). These separate crosslinking agents may be present in the one-part aqueous composition at from 0.01 to 10 weight % of the aqueous one-part composition. For example, the separate crosslinking agents may be present at from 0.1 to 8 weight %, or from 1 to 5 weight % based on the total weight of the one-part aqueous composition.

Emulsion polymers and monomers useful to prepare polymeric emulsions or dispersions are known in the art (see, e.g., “Emulsion Polymerization: Theory and Practice” by D. C. Blackley published by Wiley in 1975, “Emulsion Polymerization” by F. A. Bovey et al. published by Interscience Publishers in 1965, and “Emulsion Polymerization and Emulsion Polymers” by P. A. Lovell et al. published by Wiley Science in 1997).

The particle size of the emulsified polymeric binder may be from 50 to 500 nm, preferably from 50 to 400 nm, more preferably from 75 to 300 nm, or most preferably from 75 to 250 nm, according to certain embodiments of the invention. Particle size refers to volume average particle size which is measured using dynamic light scattering using a Nanotrac UPA 150 manufactured by Microtrac.

The emulsified polymeric binder might further comprise non-polymerizable additives. The non-polymerizable additives can be added during the polymerization or after polymerization. Non-limiting examples of suitable non-polymerizable additives include silanes, epoxysilanes, oligomeric epoxysilanes, aminosilanes, coalescents, rheology control additives, additional polymers, surfactants, plasticizers, defoamers, thickeners, biocides, solvents, rheology modifiers, wetting or spreading agents, conductive additives, thermal insulating fillers, adhesion promoters, anti-blocking agents, anti-cratering agents or anti-crawling agents, corrosion inhibitors, anti-static agents, flame retardants, optical brighteners, UV absorbers or other light stabilizers, chelating agents, cross-linking agents, flattening agents, flocculants, humectants, insecticides, lubricants, odorants, oils, waxes or anti-slip aids, soil repellants, and/or stain resistant agents

(Meth)Acrylamide and/or Derivatives Thereof

As discussed above, the emulsified polymeric binder in the aqueous coating composition includes either of both of a) an effective amount of (meth)acrylamide and/or derivatives thereof as a polymerized monomer or b) 1 weight percent or more of at least one surfactant based on the dry weight of the emulsified polymeric binder.

The emulsified polymeric binder may comprise, as a polymerized monomer, from 0.01 to 10 weight % of (meth)acrylamide or derivatives thereof based on the dry weight of the emulsified polymeric binder. The emulsified polymeric binder may comprise, as a polymerized monomer, from 0.05 to 10 weight %, preferably 0.1 to 7.5 weight %, and more preferably 0.2 to 2 weight % of (meth)acrylamide or derivatives thereof based on the dry weight of the emulsified polymeric binder. For example, the emulsified polymeric binder may comprise at least 0.1, 0.5, 1.0, 1.2, 2, 2.5, 3, 3.5, 4, 4.5, 5, 5.5, 6, 6.5, 7, 7.5, 8, 8.5, 9, or 9.5 weight percent of (meth)acrylamide or derivatives thereof based on the dry weight of the emulsified polymeric binder. The emulsified polymeric binder may comprise at most 10, 9.5, 9, 8.5, 8, 7.5, 7, 6.5, 6, 5.5, 5, 4.5, 4, 3.5, 3, 2.5, 2, 1.5, 1, 0.5, or at least 0.1 weight percent of (meth)acrylamide or derivatives thereof based on the dry weight of the emulsified polymeric binder. Combinations of (meth)acrylamide and derivatives thereof are also contemplated.

In addition to (meth)acrylamide, suitable (meth)acrylamide derivatives may include, but are not limited to N-(hydroxymethyl)acrylamide, N-(hydroxyethyl) acrylamide, 2-hydroxypropyl methacrylamide, methacrylamide poly(ethylene glycol) amine hydrochloride, N-tris(hydroxymethyl)methylacrylamide, (4-hydroxyphenyl)methacrylamide, 2-aminoethylmethacrylamide hydrochloride, N-phenylacrylamide, 2-acrylamido-2-methylpropane sulfonic acid and its salts, and mixtures thereof.

### Surfactant

As discussed above, the emulsified polymeric binder in the aqueous coating composition includes either of both of: a) an effective amount of (meth)acrylamide or derivatives thereof as a polymerized monomer or b) 1 weight percent or more of at least one surfactant based on the dry weight of the emulsified polymeric binder. The surfactant may be a separately added component, or may be a polymerizable surfactant. The surfactant may be added during the polymerization process to produce the emulsified polymeric binder, or the surfactant can be added to the emulsified polymeric binder when the polymerization is complete, either before or after adding the emulsified polymeric binder to the aqueous coating composition.

The emulsified polymeric binder may comprise from 1 to 10 weight % of at least one surfactant, preferably 1 to 5 weight %, more preferably 1 to 3 weight % based on the dried weight of the emulsified polymeric binder and the surfactant may be added to the emulsified polymeric binder during and/or after preparation of the polymeric binder. The emulsified polymeric binder may include at least 1, 1.1, 1.2, 1.3, 1.4, 1.5, 1.6, 1.7, 1.8, 1.9, 2, 2.5, 3, 3.5, 4, 5, 5.5, 6, 6.5, 7, 7.5, 8, 8.5, or 9 weight percent of at least one surfactant, based on the dried weight of the emulsified polymeric binder. The emulsified polymeric binder may include at most 10, 9.5, 9, 8.5, 8, 7.5, 7, 6.5, 6, 5.5, 5, 4.5, 4, 3.5, 3, 2.5, 2, 1.9, 1.8, 1.7, 1.6, 1.5, 1.4, 1.3, or 1.2 weight percent of the of at least one surfactant, based on the dried weight of the emulsified polymeric binder.

The surfactant may be an anionic surfactant, or non-ionic surfactant, or polymerizable surfactant, or mixtures thereof.

Examples of suitable nonionic surfactants include tert-octylphenoxyethylpoly-ethoxyethanol, dodecyloxypolyethoxyethanol, nonylphenoxyethyl-polyethoxyethanol, polyethylene glycol 2000 monooleate, ethoxylated castor oil, fluorinated alkyl esters and alkoxylates, polyoxyethylene sorbitan monolaurate, sucrose monococoate, di(2-butyl)phenoxypolyethoxyethanol, hydroxyethylcellulosepolybutyl acrylate graft copolymer, dimethyl silicone polyalkylene oxide graft copolymer, poly(ethylene oxide)poly(butyl acrylate) block copolymer, block copolymers of propylene oxide and ethylene oxide, 2,4,7,9-tetramethyl-5-decyne-4,7-diol ethoxylated with 30 moles of ethylene oxide, N-polyoxyethylenelauramide, N lauryl-N-polyoxyethyleneamine and polyethylene glycol dodecyl thioether. Other non-limiting examples of suitable nonionic emulsifiers include acyl, alkyl, oleyl, and alkylaryl ethoxylates. These products are commercially available, for example, under the tradename Genapol™, Lutensol™ or Emulan™. They include, for example, ethoxylated mono-, di-, and tri-alkylphenols (EO degree: 3 to 80, alkyl substituent: C4 to C12) and also ethoxylated fatty alcohols (EO degree: 3 to 80; alkyl: C8 to C36), especially C10-C14 fatty alcohol (EO 3-80) ethoxylates, C11-C15 oxo-process alcohol (EO 3-80) ethoxylates, C16-C18 fatty alcohol (EO 3-80) ethoxylates, C11 oxo-process alcohol (EO 3-80) ethoxylates, C13 oxo-process alcohol (EO 3-80) ethoxylates, polyoxyethylenesorbitan monooleate with 20 ethylene oxide groups, copolymers of ethylene oxide and propylene oxide having a minimum ethylene oxide content of 10% by weight, the polyethylene oxide (EO 3-80) ethers of oleyl alcohol, and the polyethene oxide (EO 3-80) ethers of nonylphenol. Preferred non-ionic surfactants include ethoxylated mono-, di-, and tri-alkylphenols (EO degree: 3 to 80, alkyl substituent: C4 to C12), ethoxylated fatty alcohols (EO degree: 3 to 80; alkyl: C8 to C36), and ethoxylated C11-C15 oxo alcohols (EO 3-80).

Examples of suitable anionic surfactants include sodium sulfonate, sodium lauryl sulfate, sodium lauryl ether sulfate, sodium dodecylbenzenesulfonate, potassium stearate, sodium dioctyl sulfosuccinate, sodium dodecyldiphenyloxide disulfonate, nonylphenoxyethylpolyethoxyethyl sulfate ammonium salt, sodium styrene sulfonate, sodium dodecyl allyl sulfosuccinate, sodium or ammonium salts of phosphate esters of ethoxylated nonylphenol, sodium octoxynol-3-sulfonate, sodium cocoyl sarcocinate, sodium 1-alkoxy-2-hydroxypropyl sulfonate, sodium α-olefin (C14-C16) sulfonate, sulfates of hydroxyalkanols, tetrasodium N-(1,2-dicarboxy ethyl)-N-octadecylsulfosuccinamate, disodium N-octadecylsulfosuccinamate, disodium alkylamido polyethoxy sulfosuccinate, disodium ethoxylated nonylphenol half ester of sulfosuccinic acid and the sodium salt of tert-octylphenoxyethoxypolyethoxyethyl sulfate and combinations thereof. Preferred anionic surfactants include sodium lauryl sulfate, sodium dodecylbenzenesulfonate, sodium dioctyl sulfosuccinate, sodium dodecyldiphenyloxide disulfonate, and sodium α-olefin (C14-C16) sulfonate.

Polymerizable surfactant is also known as reactive surfactant, which is a chemical compound containing at least one ethylenically unsaturated double bond capable of polymerizing with the monomer mixtures while also containing hydrophobic and hydrophilic moieties similar to conventional surfactants. The suitable polymerizable surfactants can be anionic, non-ionic, or mixtures thereof. Suitable examples include polyoxyethylene styrenated phenyl ether ammonium sulfate with propenyl reactive group, polyoxyethylene nonyl phenyl ether with propenyl reactive group, ammonium polyoxyethylene alkylether sulfuric ester with allyl reactive groups. These products are commercially available, for example, Hitenol BC-10, Hitenol BC-20, Hitenol AR-10, Hitenol AR-1025, Hitenol AR-20, Noigen RN-10, Noigen RN-20, Reasoap SR-10, Reasoap SR-20, Reasoap SR-1025, Reasoap ER-10, Reasoap ER-20. Preferred polymerizable surfactants include polyoxyethylene styrenated phenyl ether ammonium sulfate with propenyl reactive group and ammonium polyoxyethylene alkylether sulfuric ester with allyl reactive groups.

### Pigment

The composition includes at least one pigment. As used herein, a pigment is a white or colored material that is completely or nearly insoluble in water and has the ability to impart color or hiding to the dried coating composition.

The composition includes from 1 to 30 weight %, preferably from 3 to 25 weight %, and more preferably from 5 to 20 weight % of one or more pigments, based on the total weight of aqueous composition.

Non-limiting examples of suitable pigments include inorganic white pigments such as titanium dioxide, preferably in the rutile form, barium sulfate, zinc oxide, zinc sulfide, basic lead carbonate, antimony trioxide, lithopone (zinc sulfide+barium sulfate); and colored pigment including cadmium pigments such as cadmium yellow, cadmium red, cadmium green, cadmium orange, cadmium sulfoselenide; chromium pigments such as chrome yellow and chrome green (viridian); cobalt pigments such as cobalt violet, cobalt blue, cerulean blue, aureolin (cobalt yellow); copper pigments such as Azurite, Han purple, Han blue, Egyptian blue, Malachite, Paris green, Phthalocyanine Blue BN, Phthalocyanine Green G, verdigris; iron oxide pigments such as sanguine, caput mortuum, oxide red, red ochre, yellow ochre, Venetian red, Prussian blue, raw sienna, burnt sienna, raw umber, burnt umber; lead pigments such as lead white, cremnitz white, Naples yellow, red lead, lead-tin-yellow; manganese pigments such as manganese violet; mercury pigments such as vermilion; titanium pigments such as titanium dioxide (titanium white) titanium yellow, titanium beige, titanium black; zinc pigments such as zinc white, zinc ferrite, zinc yellow; aluminum pigment such as aluminum powder; carbon pigments such as carbon black (including vine black, lamp black), ivory black (bone charcoal); ultramarine pigments (based on sulfur) such as ultramarine, ultramarine green shade.

### Water-Soluble Silicate

The one-part aqueous coating composition comprises, consists of, or consists essentially of at least one of inorganic silicate salts, sodium silicate, potassium silicate, lithium silicate, rubidium silicate, ammonium silicate, orthosilicates, or a mixture thereof.

The aqueous composition includes 0.1 to 10 weight %, preferably 1 to 8 weight %, more preferably 2 to 7 weight % of a water-soluble silicate. For example, the aqueous composition may include at least 0.1, 0.5, 1.0, 1.2, 2, 2.5, 3, 3.5, 4, 4.5, 5, 5.5, 6, 6.5, 7, 7.5, 8, 8.5, 9, or 9.5 weight percent of a water soluble silicate based on the weight of the aqueous composition. The aqueous composition a) may include at most 10, 9.5, 9, 8.5, 8, 7.5, 7, 6.5, 6, 5.5, 5, 4.5, 4, 3.5, 3, 2.5, 2, 1.5, 1, 0.5, or at most 0.1 weight percent of water soluble silicate based on the wet weight of the polymeric composition.

As used herein, “silicate” refers to any inorganic salt silicate, including preferably compounds having the formula M2xSiyO2y+x, M being alkali metal ions such as Li+, Na+, K+Rb+, or ammonium ion NH4+. Non-limiting examples of suitable water-soluble silicates include inorganic silicate salts, sodium silicate, potassium silicate, lithium silicate, rubidium silicate, ammonium silicate, orthosilicates, or mixtures thereof.

In one embodiment, the at least one silicate may comprise, consist of or consist essentially of at least one of sodium silicate, potassium silicate, lithium silicate, rubidium silicate, ammonium silicate, orthosilicates, inorganic silicate salts, or a mixture thereof. Potassium silicate, sodium silicate and lithium silicate are preferred. More preferred are potassium silicate and lithium silicate.

### Filler

Filler, as used herein is defined as an ingredient that does not provide color or hiding. If present, the filler may be present at from 0 to 60, preferably from 5 to 50, and more preferably from 10 to 40 weight percent of one or more fillers, based on the total weight of aqueous composition.

Non-limiting examples of fillers are alkaline earth metal carbonates such as calcium carbonate, clay minerals, aluminosilicates such as kaolin, andalusite, kyanite, and sillimanite, alkaline earth metal sulfate such as calcium sulfate and barium sulfate, talc, aluminum stearate, diatomaceous earth, wollastonite, nephelene syenite, alumina, silica, and silicon oxide, or combinations thereof.

### Weight Ratio of Emulsified Polymeric Binder to the Water-Soluble Silicate

As mentioned above, the inventors have discovered that in order to provide the desired adhesion of the dried coating composition to the cementitious and/or masonry substrate and storage stability as a one-part composition, the weight ratio of the emulsified polymeric binder to the water-soluble silicate in the aqueous coating composition on dry weight basis is from 65:35 to 95:5, preferably from 70:30 to 90:10, more preferably from 75:25 to 85:15 on a dry weight basis.

### Pigment Volume Concentration (PVC)

The PVC of the aqueous coating composition is defined as:

$$\frac{dry volume of ( pigment + filler )}{dry volume of ( pigment + filler + water soluble silicate + p o l y meric binder )} \times 100.$$

The pigment (PVC) of the aqueous coating composition may be from 5% to 85%, preferably from 15% to 75%, more preferably from 20% to 70%.

### Organic Dye

According to an embodiment, the aqueous coating composition may include an organic dye. Unlike the pigment, the dye is soluble in the aqueous coating composition. Non-limiting examples of suitable dyes are Alcian Blue, Ingrain Blue, Alcian yellow GXS, Sudan orange, Ingrain yellow 1, Alizarin, Mordant red 11, Alizarin Red S, Mordant red 3, Alizarin yellow GG, Mordant yellow 1, Alizarin yellow R, Mordant orange 1, Azophloxin, Azogeranin B, Acid red 1, Bismarck brown R, Vesuvine brown, Bismarck brown Y, Vesuvine Phenylene brown, Basic brown, Brilliant cresyl blue, Cresyl blue BBS, Basic dye, Chrysoidine R, Basic orange 1, Chrysoidine Y, Basic orange 2, Congo red, Direct red 28, Crystal violet, Basic violet 3, Ethyl Green, Fuchsin acid, Acid violet 19, Gentian violet, Basic violet 1, Janus green, Lissamine fast yellow, Yellow 2G, Malachite green, Martius yellow, Acid yellow 24, Meldola blue, Phenylene blue, Basic blue 6, Metanil yellow, Acid yellow 36, Methyl orange, Acid orange 52, Methyl red, Acid red 2, Naphthalene black 12B, Amido black 10B, Acid black 1, Naphthol green B, Acid green 1, Naphthol yellow S, Acid yellow 1, Orange G, Acid orange 10, Purpurin, Verantin, Rose Bengal, Acid red 94, Sudan IL, Solvent orange 7, Titan yellow, Direct yellow 9, Tropaeolin O, Sulpho orange, Acid orange 6, Acid orange 5, Tropaeolin OOO, range IL, Acid orange 7, Victoria blue 4R, Basic blue 8, Victoria blue B, Basic blue 26, Victoria blue R, Basic blue 11, or Xylene cyanol FF.

### Viscosity Stabilizers

In an embodiment, the composition does not include any intentionally added viscosity stabilizers comprising an amine. Such viscosity stabilizers may be specifically designed for coating compositions that contain latex and silicate such as intentionally added amine intended to render the composition stable. The one-part composition may include less than 1 weight %, less than 0.5 weight %, less than 0.1 weight %, less than 0.05 weight % of each of such intentionally added viscosity stabilizers comprising an amine, i.e. if a mixture of such viscosity stabilizers is added, each component in the mixture does not exceed the above limitations. According the another embodiment, the total of the viscosity stabilizers comprising an amine may not exceed the above limits. Such viscosity stabilizers comprising an amine which may be excluded from this invention include those according to the formula:

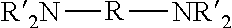

where R may be (CH₂)ₙ with n=1-8 or R may be (CH₂)n-X—CH₂) with X═N—R′; and
where R′ may be CH₃; —CH₂—CH₃; CH₂—CH₂—OH; —CH₂—CH(OH)—CH₃, which may be identical or different from each other.
N, N, N′, N′-tetrakis (2-hydroxypropyl) hexane-1,6-diamine is exemplary.

Amines of the following formula are also not present or present at the low levels disclosed above:

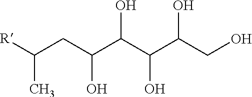

where R¹ is C1-C4 alkyl, CH₂CH₂OH or CH₂CH(CH₃)OH.

Also not present or present at the very low levels disclosed above are amines and/or organic quaternary ammonium compounds having a weight-average molecular weight in the range of 120 and 10,000.

Ammonia and ammonium hydroxide are not considered to be viscosity stabilizers and therefore are not excluded.

### Additives

The one-part composition may further comprise at least one optional additive. Optional additives as used herein excludes (i) a viscosity stabilizer, (ii) at least one of the amines listed above, (iii) an amine having a weight-average molecular weight in the range of 120 and 10,000, and/or (iv) an organic quaternary ammonium compound having a weight-average molecular weight in the range of 120 and 10,000.

Non-limiting examples of suitable additives are low molecular weight alcohol amines. such as ammonium hydroxide to neutralize latex, coalescents, leveling agents, dyes, emulsifiers, rheology control additives, additional polymers, colorants, fillers, dispersants or surfactants, plasticizers, defoamers, thickeners, biocides, solvents, rheology modifiers, wetting or spreading agents, conductive additives, thermal insulating fillers, adhesion promoters, silane additives, anti-blocking agents, anti-cratering agents or anti-crawling agents, corrosion inhibitors, anti-static agents, flame retardants, optical brighteners, UV absorbers or other light stabilizers, chelating agents, cross-linking agents, flattening agents, flocculants, humectants, insecticides, lubricants, odorants, oils, waxes or anti-slip aids, soil repellants, and stain resistant agents.

### Applications for the Aqueous Coating Composition:

A coated substrate, comprising the aqueous composition as a dried layer on at least one surface of the substrate is provided. The substrate comprises, consists of, or consists essentially of a cementitious or masonry substrate such as at least one of concrete, cement, asphalt, masonry, metals, alloys of metals, metalloids, ceramic, porcelain, granite, silica, or combinations thereof.

A method of coating a substrate is provided. The method comprises, consists of or consist essentially of applying an aqueous coating composition to the substrate. The substrate comprises, consists of, or consists essentially of at least one of concrete, cement, asphalt, masonry, metals, alloys of metals, metalloids, ceramic, porcelain, granite, silica, or combinations thereof.

A coated substrate, including the present one-part composition as a dried layer on at least one surface of the substrate is provided. The substrate may be at least one of concrete, cement, asphalt, masonry, metals, alloys of metals, metalloids, ceramic, porcelain, granite, silica, brick, building stone, such as marble, granite, or limestone, cast stone, concrete block, glass block, adobe or combinations thereof. According to an embodiment, the substrate is not subjected to special surface preparation prior to applying the inventive one-part composition. By special surface preparation, it is meant surface preparations such as sand-blasting, power washing with high pressure water, acid etching, or other forms of surface preparation as are known and used in the art to improve adhesion of a coating or primer or sealer to a surface, in particular a concrete surface or inorganic substrate surface.

The coating may be applied to cured (i.e. hydrated or partially hydrated or hardened or partially hardened) cementitious substrates or may be applied to uncured, but dry (i.e., not yet hydrated or not yet hardened) cementitious substrates.

The cementitious substrate as used herein is a substrate that comprises, consists of or consists essentially of a hydraulic cement, since non-hydraulic cements cannot be hardened (cured) when exposed to water. The most commonly used hydraulic cement is Portland cement, and these hydraulic cements have the ability to set and harden under water. The primary curing mechanism for cementitious substrates, i.e. substrates comprising, consisting of or consisting essentially of cement is hydration of the cement binder. In certain embodiments, the cement in the cementitious coating composition is or comprises Portland cement.

Suitable hydraulic cements include all such chemical combinations of lime, silica, and alumina, or of lime and magnesia, silica, and alumina and iron oxide (for example, magnesia may replace part of the lime; and iron oxide may replace part of the alumina), as are commonly known as hydraulic natural cements. Hydraulic natural cements include grappier cements, pozzolan cements, natural cements, Portland cements, white cements and aluminous cements. Pozzolan cements include slag cements made from slaked lime and granulated blast furnace slag. In some embodiments, the cement is or comprises a calcium aluminate cement, also known as high alumina cement. In some embodiments, Portland cement is preferred for its superior strength among the natural cements. In addition to ordinary construction grades of Portland cement or other hydraulic natural cements, modified natural cements and Portland cements, such as high-early strength cement, heat-resistant cement, and slow-setting cement can be used as the substrate in the present invention. Among Portland cements, any of the ASTM types I, II, III, IV, or V can be used. The term, “gray cement” as used herein refers to ordinary Portland cement. The term, “white cement” refers to white Portland cement. Portland cement can be any of the types defined in ASTM C 150, which details the types of Portland cements. Alternatively or in addition, the cements as described in ASTM C 1157 may also be used. “Masonry substrates” as used herein means inorganic substrates such as concrete, brick, building stone (e.g., marble, granite, and limestone), cast stone, concrete block, glass block, or adobe. Typically, these substrates are formed from individual units of these substances, which may be bound together by mortar. As is known in the art, mortar is itself a cementitious substrate since it is a mixture of cement, lime and sand used for laying concrete block and bricks, for example.

Importantly, as mentioned above, it is not necessary to subject the cementitious substrate to any pretreatment, chemical or physical prior to applying the inventive coating composition. Non-limiting examples of such treatment include sand-blasting, power washing with high pressure water, acid etching, degreasing or other forms of surface pre-treatment as are known and used in the art to improve adhesion of a coating or primer or sealer to a surface, in particular a cementitious or concrete surface or inorganic substrate surface.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the light-curable compositions, composite materials prepared therefrom and methods for making and using such light-curable compositions described herein. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

### Examples

### Low Temperature Coalescence (LTC)

Film formation and mud cracking at a low temperature (40° F.) indicate the degree of coalescence of paints. The drawdown films were prepared on Leneta 1B Opacity Charts with a sealed and an unsealed part using a 10-mil (254 μm) bird applicator. The paint films were placed in the 40° F. refrigerator immediately after the films were drawn down and allowed to dry for 24 hours. The dried films were examined for continuity. If cracking occurs in the dried film, the paint sample is considered not passing the LTC test.

### Adhesion Test:

Paints were applied onto concrete pavers at approximately 400 square feet per gallon. After 4 hours of drying, the second paint film was applied using the same method. Adhesion performance was measured using a crosshatch tape pull off test based on ASTM D3359B-17. For the dry adhesion test, the dried coating films were crosshatched using a sharp blade to produce a 5×5 grid, followed by applying adhesion tape to each of the films. To ensure good contact with films, the tape was rubbed firmly with a tongue depressor. The tape was then immediately pulled off with a constant force at a 180° angle. For wet adhesion test, dried coating films were prepared and cross-hatched following the same procedure described above for the dry adhesion test, except that a piece of paper towel was wet by water droplets and then applied onto the crosshatched area. Afterwards, the wet paper towel was removed and the surface of the dried coating film was blotted dry. The adhesion test was performed using the same procedure described above for the dry adhesion test.

### Paint Storage Stability Evaluation:

Wet paint storage stability was evaluated under heat aging conditions. Specifically, wet paint in a closed container was subjected to 60° C. for 4 weeks. The viscosity in Krebs Units (KU) of the wet paint was measured using a Brookfield KU-I+ viscometer before and after the heat aging test.

### Latex Synthesis:

Latex 1: 590.2 parts of deionized water and 4.6 parts of Encor® 9710 seed (40% active) latexes (Arkema) were charged into a reactor equipped with a stirrer, reflux condensers, thermocouples, and stainless steel feed lines. After the reactor was heated to 90° C., 0.5 parts of ammonium persulfate in 9.7 parts of water were added into the reactor. The monomer mixture consisting of 511.7 parts of butyl acrylate (BA), 496.4 parts of styrene (STY), 10.3 parts of acrylic acid (AA) was then fed continuously to the reactor over 200 minutes. During the monomer feed, a solution of 11.4 parts of Dowfax® 2A1 (anionic surfactant) (45%) and 17.0 parts of acrylamide (30%) in 90.4 parts of water was fed into the reactor over 180 minutes separately. In addition, 4.6 parts of ammonium persulfate in 73.4 parts of water were fed into the reactor over 210 min separately. At the end of monomer feed, 0.2 parts of DREWPLUS® L-131 (foam control agent, Ashland) in 34.4 parts of water was added into the reactor. To reduce the residual monomer concentrations, 6.1 parts of tertiary-butyl hydroperoxide (tBHP, 70% active) and 4.2 parts of sodium hydroxymethane sulfinic acid were fed over 45 minutes at 80° C. The final pH of the latex was adjusted to 9.0 using ammonium hydroxide. The final latex has solids content of 51%, volume average particle size of 215 nm and Brookfield viscosity below 500 centipoise. The minimum film formation temperature of Latex 1 was 16° C. MFFT of the latex polymer was analyzed on a rectangular temperature gradient bar. The MFFT was determined at the point where the latex formed a clear and uncracked dry film.

Latex 2 was made with the same binder composition as Latex 1, but with methyl methacrylate replacing styrene as a polymerized monomer therein.

Latex 3 was made with the same binder composition as Latex 1, but without acrylamide as a polymerized monomer therein.

Latex 4 was made with the same binder composition as Latex 1, but without acrylamide as a polymerized monomer therein, and Dowfax A21 was increased to 45.6 parts (i.e., 2 weight % based on total monomer mass).

Inventive Example 4 was prepared using the same coating composition as Inventive Example 1, but with Latex 2 replacing Latex 1 as organic binder.

Inventive Example 5 was prepared using the same paint composition as inventive Example 3, but with lithium silicate (Lithisil 25, 23 weight % solids) replacing potassium silicate (KASIL 1, 29.1 weight % solids) as inorganic binder. The solids ratio between latex and silicate was kept the same at 80/20.

Comparative Example 5 was prepared using the same paint composition as inventive Example 3, but with Latex 3 replacing Latex 1 as organic binder.

Inventive Example 6 was prepared using the same paint composition as inventive Example 3, but with Latex 4 replacing Latex 1 as organic binder.

Table 1 shows the compositions of the latex compositions used in the Examples. Table 2 and Table 3 show the compositions of the inventive examples and comparative examples at approximately 60 PVC and 30 PVC, respectively. Among the prepared coating compositions, the silicate-only paints (i.e., comparative Example 2 and comparative Example 4) showed phase separation and did not pass low temperature coalescence (LTC) testing, suggesting that silicate-only compositions suffer from poor rheology and film formation capability. In contrast, all the inventive examples passed LTC testing, demonstrating the good film formation performance of the inventive examples.

TABLE 1
Latex compositions

| Ingredient (PHM*) | Latex 1 | Latex 2 | Latex 3 | Latex 4 |
|---|---|---|---|---|
| Styrene | 48.8 | 0 | 48.8 | 48.8 |
| Methyl | 0 | 48.8 | 0 | 0 |
| methacrylate | | | | |
| Butyl acrylate | 50.2 | 50.2 | 50.2 | 50.2 |
| Acrylic Acid | 1.0 | 1.0 | 1.0 | 1.0 |
| Acrylamide | 0.5 | 0.5 | 0 | 0 |
| Dowfax 2A1 | 0.5 | 0.5 | 0.5 | 2 |

*parts per hundred main monomers that exclude acrylamide

TABLE 2
Coating compositions

| | Inventive | Inventive | Comparative | Comparative | Inventive |
|---|---|---|---|---|---|
| | Example 1 | Example 2 | Example 1 | Example 2 | Example 4 |
| Ingredient | Parts (wt) | Parts (wt) | Parts (wt) | Parts (wt) | Parts (wt) |
| Water | 284.6 | 284.6 | 284.6 | 284.6 | 284.6 |
| Trisodium | 2.4 | 2.4 | 2.4 | 2.4 | 2.4 |
| Phosphate | | | | | |
| Natrosol HBR | 2.4 | 2.4 | 2.4 | 2.4 | 2.4 |
| R-706 | 108.1 | 108.1 | 108.1 | 108.1 | 108.1 |
| Foamstar 2420 | 2.2 | 2.2 | 2.2 | 2.2 | 2.2 |
| OmyaCarb 5 | 319.4 | 319.4 | 319.4 | 319.4 | 319.4 |
| Latex | 187.6 | 187.6 | 201.8 | 319.4 | 187.6 |
| 1, 2, 3, or 4 | (Latex 1) | (Latex 1) | (Latex 1) | (Latex 1) | (Latex 2) |
| (51 wt % solids) | | | | | |
| KASIL 1 | 80.4 | 80.4 | 0 | 350.1 | 80.4 |
| (potassium | | | | | |
| silicate, 29.1 | | | | | |
| wt % solids) | | | | | |
| Texanol | 7.7 | 7.7 | 8.2 | 0 | 7.7 |
| Colortrend 808 | 0 | 20 | 0 | 0 | 0 |
| Weight ratio | 80/20 | 80/20 | 100/0 | 0/100 | 80/20 |
| between latex | | | | | |
| solids and | | | | | |
| silicate solids | | | | | |
| Pigment | 60.9% | 60.9% | 60.9% | 83.1% | 60.9% |
| volume | | | | | |
| concentration | | | | | |
| (PVC) | | | | | |
| Volatile | 30.4 | 30.0 | 33.1 | 0.0 | 30.4 |
| organic content | | | | | |
| (g/L) | | | | | |
| Organic binder | 9.6 | 9.4 | 10.4 | 0.0 | 9.6 |
| content (wt %) | | | | | |
| Silicate solid | 2.4 | 2.3 | 0 | 9.6 | 2.4 |
| content (wt %) | | | | | |

TABLE 3
Coating Compositions continued

| | Inventive | Comp. | Comp. | Comp. | Inventive | Inventive |
|---|---|---|---|---|---|---|
| Ingredient | Example 3 | Example 3 | Example 4 | Example 5 | Example 5 | Example 6 |
| Water | 174 | 260 | 165 | 174 | 174 | 174 |
| Trisodium | 2.5 | 2.5 | 2.5 | 2.5 | 2.5 | 2.5 |
| Phosphate | | | | | | |
| Natrosol HBR | 2.5 | 2.5 | 2.5 | 2.5 | 2.5 | 2.5 |
| R-706 | 128 | 128 | 128 | 128 | 128 | 128 |
| Foamstar 2420 | 2.5 | 2.5 | 2.5 | 2.5 | 2.5 | 2.5 |
| OmyaCarb 5 | 144 | 144 | 144 | 144 | 144 | 144 |
| Latex | 364 | 455 | 0 | 364 | 364 | 364 |
| 1, 2, 3, or 4 | (Latex 1) | (Latex 1) | | (Latex 3) | (Latex 1) | (Latex 4) |
| (51 wt % solids) | | | | | | |
| KASIL 1 | 161 | 0 | 712 | 161 | 161 | 161 |
| (potassium | KASIL 1 | | KASIL 1 | KASIL 1 | Lithisil 25 | KASIL 1 |
| silicate, 29.1 | | | | | | |
| wt % solids) | | | | | | |
| OR Lithisil | | | | | | |
| 25, 23 wt % | | | | | | |
| solids | | | | | | |
| Texanol | 15.0 | 18.8 | 0 | 15.0 | 15.0 | 15.0 |
| Weight ratio | 80/20 | 100/0 | 0/100 | 80/20 | 80/20 | 80/20 |
| between latex | | | | | | |
| solids and | | | | | | |
| silicate solids | | | | | | |
| Pigment volume | 32.2 | 29.0 | 57.8 | 32.2 | 32.2 | 32.2 |
| concentration | | | | | | |
| (PVC) | | | | | | |
| Volatile organic | 50.7 | 56.9 | 0 | 50.7 | 50.7 | 50.7 |
| content (g/L) | | | | | | |
| Organic binder | 18.5 | 22.9 | 0 | 18.5 | 18.5 | 18.5 |
| content (wt %) | | | | | | |
| Silicate solid | 4.7 | 0 | 17.9 | 4.7 | 4.7 | 4.7 |
| content (wt %) | | | | | | |

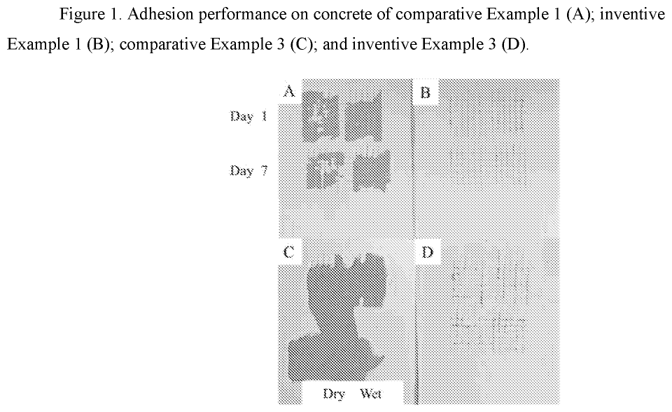

FIG. 1 shows the adhesion performance of inventive Example 1, inventive Example 3, comparative Example 1, and comparative Example 3 on concrete substrates. The results demonstrated that the inventive Example 1 and inventive Example 3 exhibited significantly better adhesion performance than Comparative Example 1 and Comparative Example 3, respectively.

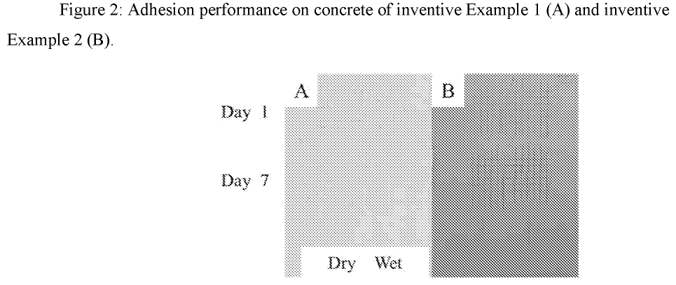

One major concern for latex-silicate hybrid paints is the storage stability and compatibility with colorant dispersion. Therefore, inventive Example 1, inventive Example 2 (tinted inventive Example 1), inventive Example 3, inventive Example 4, inventive Example 5 were subjected to heat age testing in 60° C. oven. After 4 weeks of heat age testing, no irreversible gel formation was observed for the tested inventive paints, and the viscosity in Kreb Units (KU) change for the tested paints was less than 15 units (Table 4). These results demonstrated the storage stability of the inventive latex-silicate hybrid paints without the need of viscosity stabilizers. The nearly identical storage stability of inventive Example 1 and inventive Example 2 indicated that the inventive latex-silicate hybrid paint had good compatibility with colorant dispersion. FIG. 2 showed that the adhesion performance of inventive Example 1 was equivalent to inventive Example 2 (i.e., tinted inventive Example 1). This result indicated that the addition of colorant did not compromise the adhesion performance of latex-silicate hybrid paint. The storage stability observed for inventive Example 1 and inventive Example 3 demonstrated that the inventive latex-silicate paint composition could be formulated in both 30 PVC and 60 PVC.

Lastly, the latex composition affected the stability of the coating compositions. Both styrene-acrylic and all-acrylic showed good stability, as evidenced by the minimal KU change for inventive Example 1 and inventive Example 4 after 4 week heat age testing. The presence of acrylamide functional monomer was required for latex, as demonstrated by the Comparative Example 5 that was based on Latex 3 (0 PHM of acrylamide) failing heat age testing. Alternatively, the presence of high level of surfactant in latex (Latex 4) enabled the resulting latex-silicate paint (Inventive Example 6) to have good stability, even without the (meth)acrylamide in the polymeric emulsion. In addition, the adhesion performance of all the Inventive Examples also remained almost unchanged after the heat aging storage stability test.

TABLE 4
Viscosity Change after heat aging for 4 weeks

Krebs Unit Viscosity

| Coating Composition | Initial | After heat ageing for 4 weeks |
|---|---|---|
| Inventive Example 1 | 68 | 74 |
| Inventive Example 2 | 81 | 88 |
| Inventive Example 3 | 80 | 89 |
| Inventive Example 4 | 67 | 78 |
| Inventive Example 5 | 65 | 82 |
| Comparative Example 5 | 73 | Turned into solids at Week 2 |
| Inventive Example 6 | 71 | 80 |

1. A method of coating a cementitious and/or masonry substrate, the method comprising applying a one-part aqueous coating composition to the cementitious and/or masonry substrate,
wherein the aqueous coating composition comprises:
at least one pigment,
at least one emulsified polymeric binder,
the emulsified polymeric binder comprising at least one of:
a) (meth)acrylamide or derivatives thereof as a polymerized monomer; or
b) 1 weight % or more of at least one surfactant based on the total dry weight of the total monomer in the emulsified polymeric binder;
at least one water-soluble silicate,
optionally at least one filler, and
optionally at least one additive;
wherein the one-part aqueous coating composition has:
a weight ratio of emulsified polymeric binder to the water-soluble silicate from 65:35 to 95:5 on a dry weight basis; and
a pigment volume concentration (PVC) from 5% to 85%;
wherein the PVC is defined as:
$$\frac{dry volume of ( pigment + filler )}{dry volume of ( pigment + filler + water soluble silicate + p o l y meric binder )} \times 100.$$

2. The method of claim 1, wherein the cementitious and/or masonry substrate comprises at least one of concrete, stone, brick, or masonry.

3. The method of claim 1, wherein the one-part aqueous coating composition includes no more than 0.5 weight % of each of one or more intentionally added viscosity stabilizers, each of which comprises an amine.

4. The method of claim 1, wherein the emulsified polymeric binder comprises, as a polymerized monomer, from 0.01 to 10 weight % of (meth)acrylamide or derivatives thereof, based on the dry weight of the polymerized monomers in the emulsified polymeric binder.

5. The method of claim 1, wherein the emulsified polymeric binder comprises from 1 to 10 weight % of at least one surfactant, wherein the surfactant is added during and/or after preparation of the polymeric binder.

6. The method of claim 1, wherein the surfactant comprises at least one of an anionic surfactant, a non-ionic surfactant, or a polymerizable surfactant; wherein:
the anionic surfactant comprises at least one of sodium lauryl sulfate, sodium dodecylbenzenesulfonate, sodium dioctyl sulfosuccinate, sodium dodecyldiphenyloxide disulfonate, or sodium α-olefin (C14-C16)sulfonate;
the non-ionic surfactant comprises at least one of ethoxylated mono-, di-, and tri-alkylphenols (EO degree: 3 to 80, alkyl substituent: C4 to C12), or ethoxylated fatty alcohols (EO degree: 3 to 80; alkyl: C8 to C36), or ethoxylated C11-C15 oxo alcohols (EO 3-80); and
the polymerizable surfactant comprises at least one of polyoxyethylene styrenated phenyl ether ammonium sulfate with propenyl reactive group, or ammonium polyoxyethylene alkylether sulfuric ester with allyl reactive groups.

7. The method of claim 1, wherein the at least one water-soluble silicate comprises at least one of inorganic silicate salts, sodium silicate, potassium silicate, lithium silicate, rubidium silicate, ammonium silicate, orthosilicates, or a mixture thereof.

8. The method of claim 1, wherein the at least one pigment comprises titanium dioxide.

9. The method of claim 1, wherein the at least one filler comprises at least one of calcium carbonate, clay, talc, or combinations thereof.

10. The method of claim 1, wherein the emulsified polymeric binder comprises, as polymerized monomer, at least one of a vinyl aromatic or derivatives thereof, alkyl (meth)acrylate or derivatives thereof, or (meth)acrylic acid.

11. The method of claim 1, wherein the polymeric binder further comprises, as polymerized monomer, from 0.01 to 5 weight % of: at least one crosslinkable co-monomer, at least one silane co-monomer, at least one phosphate co-monomer, or at least one sulfonate co-monomer.

12. The method of claim 1, further comprising an organic dye.

13. A coated cementitious and/or masonry substrate provided by the method of claim 1.

14. A one-part aqueous composition for coating a cementitious and/or masonry substrate, the one-part aqueous composition comprising:
at least one pigment;
at least one emulsified polymeric binder comprising at least one of:
a) (meth)acrylamide or derivatives thereof as a polymerized monomer; or
b) at least one surfactant;
at least one water-soluble silicate;
optionally at least one filler; and
optionally at least one additive;
wherein the one-part aqueous coating composition has a pigment volume concentration (PVC);
wherein the PVC is defined as:
$$\frac{dry volume of ( pigment + filler )}{dry volume of ( pigment + filler + water soluble silicate + p o l y meric binder )} \times 100.$$

15. The one-part aqueous composition of claim 14, comprising:
0.01 to 10 weight % of (meth)acrylamide or derivatives thereof in the emulsified polymeric binder from based on the total dry weight of the polymerized monomers in the emulsified polymeric binder;
1 weight % or more of the at least one surfactant, based on the total dry weight of the polymerized monomers in the emulsified polymeric binder;
a weight ratio of emulsified polymeric binder to the water-soluble silicate from 65:35 to 95:5 on a dry weight basis; and
wherein the PVC of the one-part aqueous coating composition is from 5% to 85%.

16. The one-part aqueous composition of claim 14, comprising from 0.01 to 10 weight % (meth)acrylamide or derivatives thereof in the emulsified polymeric binder, based on the dry weight of the polymerized monomers in the emulsified polymeric binder.

17. The one-part aqueous composition of claim 14, wherein the emulsified polymeric binder comprises from 1 to 10 weight % of the surfactant, based on the dry weight of the polymerized monomers in the emulsified polymeric binder.

18. The one-part aqueous composition of claim 14, wherein the at least one water-soluble silicate comprises at least one of inorganic silicate salts, sodium silicate, potassium silicate, lithium silicate, rubidium silicate, ammonium silicate, orthosilicates, or a mixture thereof.

19. The one-part aqueous composition of claim 14, wherein the at least one pigment comprises titanium dioxide.

20. The one-part aqueous composition of claim 14, wherein the at least one filler comprises at least one of calcium carbonate, clay, talc, or combinations thereof.

21. The one-part aqueous composition of claim 14, wherein the emulsified polymeric binder further comprises, as polymerized monomer, at least one of a vinyl aromatic or derivatives thereof, alkyl (meth)acrylate or derivatives thereof, or (meth)acrylic acid.

22. The one-part aqueous composition of claim 14, wherein the polymeric binder further comprises, as polymerized monomer, 0.01 to 5 weight % of at least one of a crosslinkable co-monomer, a silane co-monomer, a phosphate co-monomer, or a sulfonate co-monomer.

23. The one-part aqueous composition of claim 14 further comprising an organic dye.
